(19) United States
(12) Patent Application Publication
(10) Pub. No.: US 2002/0156916 A1
(43) Pub. Date: Oct. 24, 2002

(54) Network relay installation, port monitoring method, and computer program for executing this method

(75) Inventor: Ryo Watanabe, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., Tokyo (JP)

(21) Appl. No.: 10/022,775

(22) Filed: Dec. 20, 2001

(30) Foreign Application Priority Data
Apr. 23, 2001 (JP) 2001-124917

(51) Int. Cl. G06F 15/173

(52) U.S. Cl. 709/238; 709/250

(57) ABSTRACT

Provides a network relay installation capable of accurately outputting packets to be input to/output from a specific port from a monitoring port, by arranging such that a packet in the same status as that of a packet input to/output from a port that is set up as a monitored port, is output from other port that is set up as a monitoring port to an external monitoring unit.

### FIELD OF THE INVENTION

The present invention relates to a network relay installation, a port monitoring method, and a computer program for executing this method. Particularly, the invention relates to a network relay installation that can be applied to routers, bridges, brouters, and switching hubs, a port monitoring method, and a computer program for executing this method.

### BACKGROUND OF THE INVENTION

In recent years, along the increase in the network capacity and transmission speed as represented by the Gigabyte Ethernet, a high-speed transmission in a network relay installation has been demanded. In the field of network relay installations that execute switching and routing between a plurality of ports, there have appeared ones that execute switching processing by hardware instead of the conventional software processing, in order to meet the high-speed transmission demand. Under the accelerated situation toward higher-speed transmission, there is a trend of a shift of the switching processing function from the conventional integrated processing in one module to a distributed processing for carrying out larger-capacity processing.

According to a conventional network relay installation, an address resolution processing logic for determining an output port is provided for each input section of each port or a few ports. Further, a forwarding section like a crossbar switch logic for efficiently forwarding packets is provided to decentralize the relaying processing function to many blocks. These blocks execute processing independently while co-operating with each other, thereby to realize a larger-capacity processing. Network relay installations that realize the routing as well as the switching based on this kind of system have appeared in recent years.

In the mean time, along the diffusion of a switched network as represented by a switching hub, there has been realized a technique for transmitting packets that are input and output at monitoring ports provided within the installation, as a technique for monitoring traffics that flow through a network without disconnecting lines. This is usually realized by transferring monitored packets to output ports and monitoring ports.

Further, as conventional inter-LAN connecting apparatuses, there have been used bridges, routers, and brouters. The bridge connects between different LANs, and has a function of determining whether packets are to be transmitted or abandoned, by referring to a source address and a destination address of a data link layer. The router has a function of analyzing up to a header of a network layer, determining whether an output is to be made to the destination address or not, and determining an optimum route and passing packets through this route, in the case of making an output. The brouter has both functions of the bridge and the router. In general, these inter-LAN connecting apparatuses store information on collisions and error packets that occur on LAN transmission lines, and transmit this information to an exclusive monitoring/managing unit or an SNMP (single network management protocol) manager unit, thereby to mange statistical information that occur on the LANs.

As techniques for monitoring packet traffics on the network, the following techniques are known. For example, Japanese Patent Application Laid-open (JP-A) No.8-116334 discloses a technique of transmitting an instruction for making copy of packets having a terminal address to be monitored, and transferring the copy to a designated unit. When each inter-LAN connecting apparatus has detected the packets having the instructed address, this apparatus makes copy of the packets, stores the copy in a storage, and transfers the data stored in the storage to the instructed designated unit. The designated unit collects the data transmitted from each inter-LAN connecting apparatus, and monitors the data.

JP-A No.9-312662 discloses the following technique. A packet communication apparatus receives transmission packets that have been set with communication monitored information. When this packet communication apparatus transmits the transmission packets that have been set with the communication monitor information, to a terminal or other communication apparatus, the transmission packet monitoring unit stores and manages the input information and the output information of the transmitted packets.

### SUMMARY OF THE INVENTION

It is an object of this invention to provide a network relay installation capable of accurately outputting packets to be input to/output from a specific port, from a monitoring port, a port monitoring method, and a computer program for executing this method.

In order to achieve the above object, according to one aspect of the present invention, there is provided a network relay installation that has a plurality of ports for mutually connecting a plurality of network segments, and outputs packets to be input to/output from a port that becomes a monitored port, from a port that becomes a monitoring port to a monitoring unit, wherein each of the plurality of ports comprises: an address resolution processing section that transfers output destination port information that specifies an output destination port and a monitoring port, to a forwarding processing section, and at the same time, adds control information that contains information showing whether the self port is in the status of being set up as a monitored port or not and transformation information for transforming packets, to the received packets when the packet transformation is necessary, and transfers the transformed packets to the forwarding processing section, when the self or the output destination port is in the status of being set up as a monitored port when the packets have been received from the network segment; an output processing section that decides whether received packets are from the monitored port or not by referring to the control information when the self port is in the status of being set up as a monitoring port at the time when the packets added with the control information and the transformation information have been input from the forwarding processing section, and transforms the packets based on the transformation information and transmits the transformed packets to the monitoring unit when the received packets are not from the monitored port, and transmits the packets to the monitoring unit without transforming the packets when the received packets are from the monitored port; and the forwarding processing section that transfers the packets added with the control information and the transformation information to a designated port, according to the output destination information input from the address resolution processing section.

Further, according to another aspect of the invention, there is provided a port monitoring method for monitoring a port that outputs packets to be input to/output from a specific port from a monitoring port, out of a plurality of ports for mutually connecting a plurality of network segments, the port monitoring method comprising the steps of: transferring, at each port, output destination port information that specifies an output destination port and a monitoring port, to a forwarding processing section, and at the same time, adding control information that contains information showing whether the self port is in the status of being set up as a monitored port or not and transformation information for transforming packets, to the received packets when the packet transformation is necessary, and transferring the transformed packets to the forwarding processing section, when the self or the output destination port is in the status of being set up as a monitored port when the packets have been received from the network segment; transferring, at the forwarding processing section, the packets added with the control information and the transformation information to a designated port, according to the output destination information; and deciding whether received packets are from the monitored port or not by referring to the control information when the self port is in the status of being set up as a monitoring port at the time when the packets added with the control information and the transformation information have been input from the forwarding processing section, and transforming the packets based on the transformation information and transmitting the transformed packets to the monitoring unit when the received packets are not from the monitored port, and transmitting the packets to the monitoring unit without transforming the packets when the received packets are from the monitored port.

Other objects and features of this invention will become understood from the following description with reference to the accompanying drawings.

### BRIEF DESCRIPTION OF THE DRAWINGS

FIG. 1 is a diagram showing a hardware structure of a network relay installation according to the present invention;

FIG. 2A and FIG. 2B are diagrams showing packet structure examples;

FIG. 3 is a diagram showing a network connection example of the network relay installation shown in FIG. 1;

FIG. 4 is a flowchart for explaining a monitoring processing when a port # A (a monitored port) has received a packet for a port # B;

FIG. 5 is a flowchart for explaining a monitoring processing when the port# B has received a packet for the port# A (the monitored port).

### DETAILED DESCRIPTION

The present invention has been achieved in order to solve the following problems.

However, in the multi-port high-speed relay installation that realizes the packet transformation processing like routing by distributed processing using hardware, there are the following problems for a certain monitoring port to monitor a packet transmission of a specific port or between ports.

According to the above distributed processing system, in order to efficiently process packets, destination I/F information is obtained and a routing processing (replacing of an IP header) is carried out, at the time of an address resolution processing at the input processing side. Accordingly, as the packet to be output to a specific port have been monitored, the packets after the modification are output from the monitoring port as the packet of the input side. Consequently, it is not possible to execute a correct monitoring. Further, at the input processing side, it is necessary to prepare two kinds of packets, one for transmission to the monitoring port and the other for transmission to a normal port. It is necessary to transmit these packets separately to the respective ports. This holds a problem of reduction in the processing performance due to the holding of buffers, complex processing, and copying processing.

A preferred embodiment of a network relay installation, a port monitoring method, and a program for executing this method according to the present invention will be explained in detail below with reference to the drawings. A hardware structure of a network relay installation, a network connection example of the network relay installation, and an operation example of the network relay installation will be explained in this order.

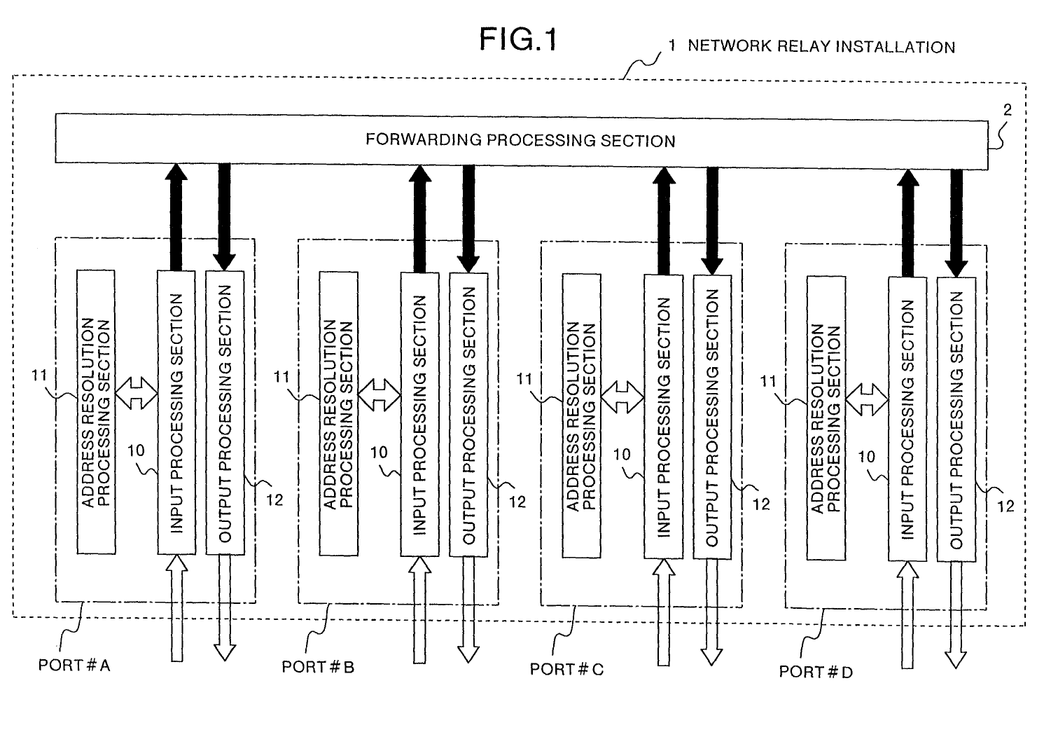

FIG. 1 is a diagram showing a hardware structure of a network relay installation according to the present invention. In FIG. 1, a reference number 1 denotes a network relay installation. This network relay installation 1 consists of four port numbers # A to # D that are connected to network segments, for inputting and outputting packets to and from the network segments respectively, and a forwarding processing section 2 for transferring packets input from the ports to suitable ports by referring to output port information.

The ports # A to # D have the same hardware structure, and each port has an input processing section 10, and address resolution processing section 11, and an output processing section 12.

Based on the setting, each of the ports # A to # D can function as a monitored port in which packets that are input to and output from this port are monitored, and as a monitoring port that outputs packets input to and output from the monitored port, to a monitoring unit that is connected to this monitoring port. In the network relay installation 1, the following settings are carried out for each of the ports # A to # D.

Setting up of a monitored port: this is a setting up of a port as a monitored port.

Setting up of a monitoring port: this is a setting up of a port as a monitoring port.

Monitoring port ID: this is an ID to show a status of a port as a monitoring port.

Monitored port ID: this is an ID to show a status of a port as a monitored port.

An outline operation of the network relay installation 1 will be explained next. At each port, when the self or an output destination port is in the status of being set up as a monitored port at the time when the input processing section 10 has received packets from the network segment, the address resolution processing section 11 transfers output destination port information that specifies the output destination port and a monitoring port, to the forwarding processing section 2. At the same time, the address resolution processing section 11 adds control information that contains information showing whether the self port is in the status of being set up as a monitored port or not and transformation information for transforming packets, to the received packets when the packet transformation is necessary, and transfers the transformed packets to the forwarding processing section 2.

The forwarding processing section 2 transfers the packets added with the control information and the transformation information to a designated port, according to the output destination information that has been input from the address resolution processing section 11 of the port.

When the self port is in the status of being set up as a monitoring port at the time when the packets added with the control information and the transformation information have been input from the forwarding processing section 2, the output processing section 12 of the port decides whether the received packets are from the monitored port or not by referring to the control information. When the received packets are not from the monitored port, the output processing section 12 transforms the packets based on the transformation information and transmits the transformed packets to the monitoring unit. In the mean time, when the received packets are from the monitored port, the output processing section 12 transmits the packets to the monitoring unit without transforming the packets. Further, when the self port is in the status of not being set up as a monitoring port, the output processing section 12 of the port transforms the packets based on the transformation information, and transmits the transformed packets to the network segment.

The packets in the same status as that of the packets input to and output from the monitored port are output from the monitoring port, in the manner as described above. Next, each portion of the ports # A to # D will be explained in detail.

(1) Input Processing Section

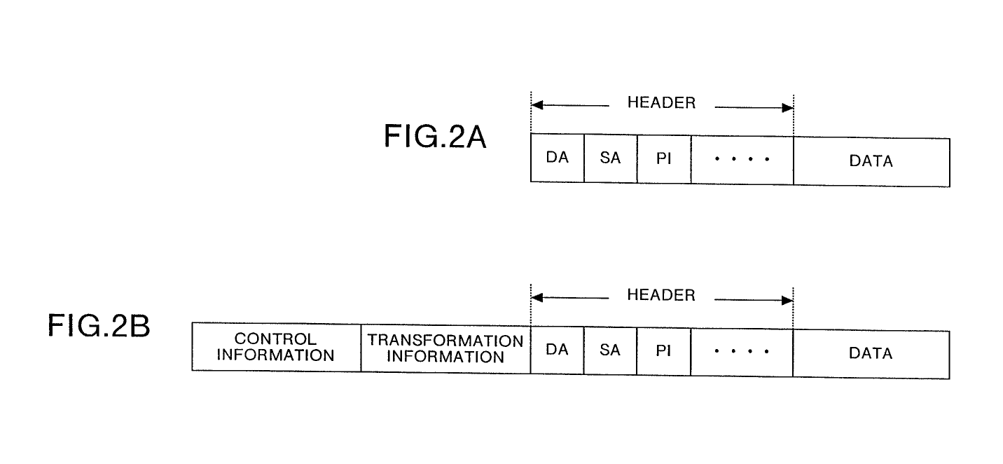

When the input processing section 10 has received packets, the input processing section 10 temporarily stores the received packets. FIG. 2A shows a structure example of a received packet. In this example, the received packet contains a header (DA: destination address, SA: source address, and PI: protocol identifier), and data.

(2) Address Resolution Processing Section

The address resolution processing section 11 manages various kinds of information (MAC address of Next Hop, port ID, monitoring port ID, monitored port ID, etc.) for generating output destination port information, control information, and transformation information. The address resolution processing section 11 extracts data from a predetermined field of a packet that has been input to the input processing section 10, and generates output destination port information, control information, and transformation information, by using the various kinds of information.

More specifically, when the address resolution processing section 11 has received a packet in the input processing section 10, the address resolution processing section 11 searches a predetermined field of the packet for packet transmission destination information. The address resolution processing section 11 generates output destination port information that specifies an ID of an output destination port corresponding to a packet transmission destination, and transfers this generated information to the forwarding processing section 2. When the self port or the output destination port is in the status of being set up as a monitored port, the address resolution processing section 11 adds the monitoring port ID to the output destination port information, and transfers this information to the forwarding processing section 2.

The address resolution processing section 11 searches a predetermined field of the packet that has been input to the input processing section 10 for information according to the packet transformation, generates control information and transformation information, and adds the control information and the transformation information to the received packet. Then, the address resolution processing section 11 transfers this packet to the forwarding processing section 2. FIG. 2B shows a structure example of a packet added with control information and transformation information.

The control information contains types of subsequent packets (such as, a switching packet, and a routing packet, for example), and a monitor packet flag, etc. When the self port has been set up as a monitored port, a valid status “1” is set to this monitor packet flag. When the self port has not been set up as a monitored port, an invalid status “0”? is set to this monitor packet flag.

The transformation information is the information to be added to the packet when it is necessary to transform the packet in the output processing section 12 of the output destination port. When it is not necessary to transform the packet, this transformation information is omitted, and the packet is not transformed in the output processing section 12 of the output destination port.

(4) Output Processing Section

When a packet added with control information and transformation information has been input from the forwarding processing section 2 to the output processing section 12 of the port having a valid monitor port setting, this output processing section 12 decides whether the monitor port flag in the control information has a valid setting or an invalid setting. When the monitor port flag has a valid setting, the output processing section 12 of the port having a valid monitor port setting does not transform the packet, and transmits the packet to the monitoring unit in the same status as that when the packet has been input to the monitored port. On the other hand, when the monitor port flag has an invalid setting, the output processing section 12 of the port having a valid monitor port setting transforms the packet according to the transformation information, and transmits the transformed packet to the monitoring unit in the same status as that when the packet has been output from the monitored port.

When a packet added with control information and transformation information has been input from the forwarding processing section 2 to the output processing section 12 of the port not having a valid monitor port setting, this output processing section 12 transforms the packet according to the transformation information, and transmits the transformed packet to the network segment. Further, when the packet is not added with transformation information (that is, when it is not necessary to transform the packet), the output processing section 12 of the port not having a valid monitor port setting transmits the packet straight to the network segment.

(5) Forwarding Processing Section

When output destination port information and a packet added with control information and transformation information have been input from the port to the forwarding processing section 2, the forwarding processing section 2 transfers the packet added with the control information and the transformation information to the port of a transfer destination designated by the output destination port information.

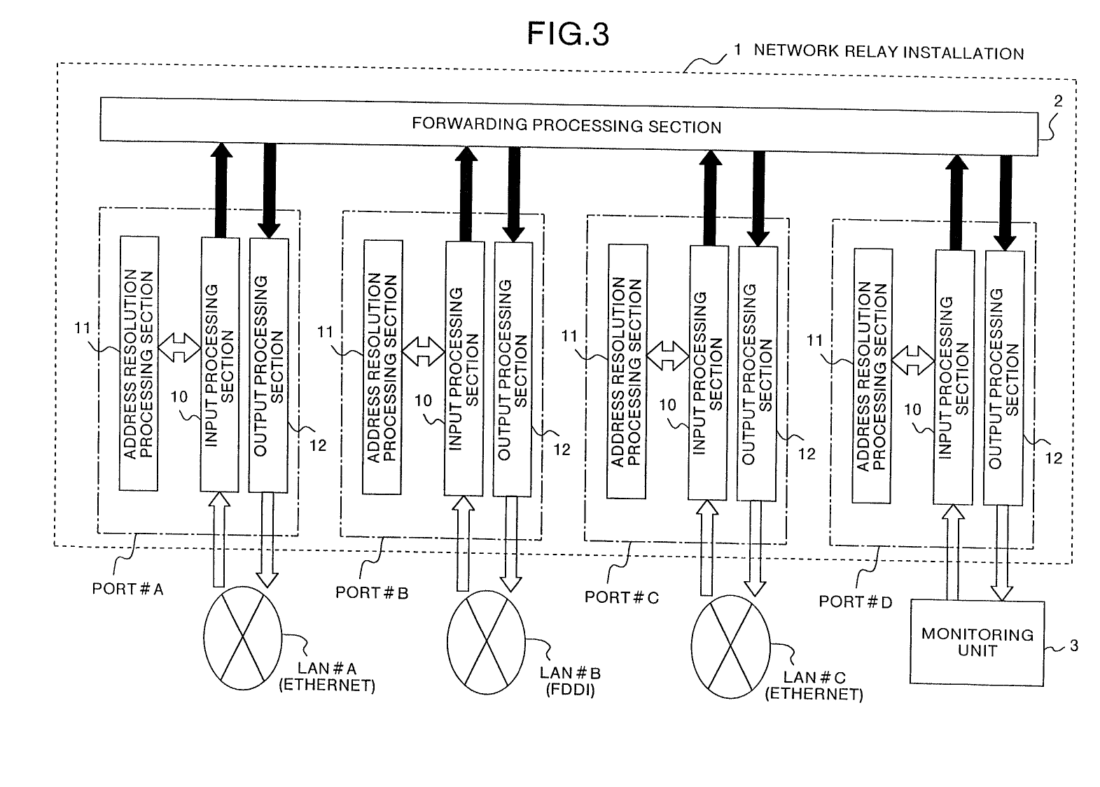

FIG. 3 shows a network connection example of the network relay installation 1 shown in FIG. 1. It is assumed that in the network relay installation 1 shown in FIG. 3, the port # A has been set up as a monitored port, and the port # D has been set up as a monitoring port. In the network relay installation 1 shown in FIG. 3, the port # A has been connected to a LAN # A (Ethernet), the port # B has been connected to a LAN # B (FDDI), the port # C has been connected a LAN # C (Ethernet), and the port # D has been connected to a monitoring unit 3. The monitoring unit 3 is for monitoring packet traffics on the network to provide various kinds of diagnostic information to a network manager to enable the network manager to set problems, evaluate performance, and determine suitable network parameters. In FIG. 3, packets input to and output from the monitored port # A of the network relay installation 1 are output to the monitoring unit 3 from the monitoring port # D, and the packet traffics of the monitored port # A are monitored by the monitoring unit 3.

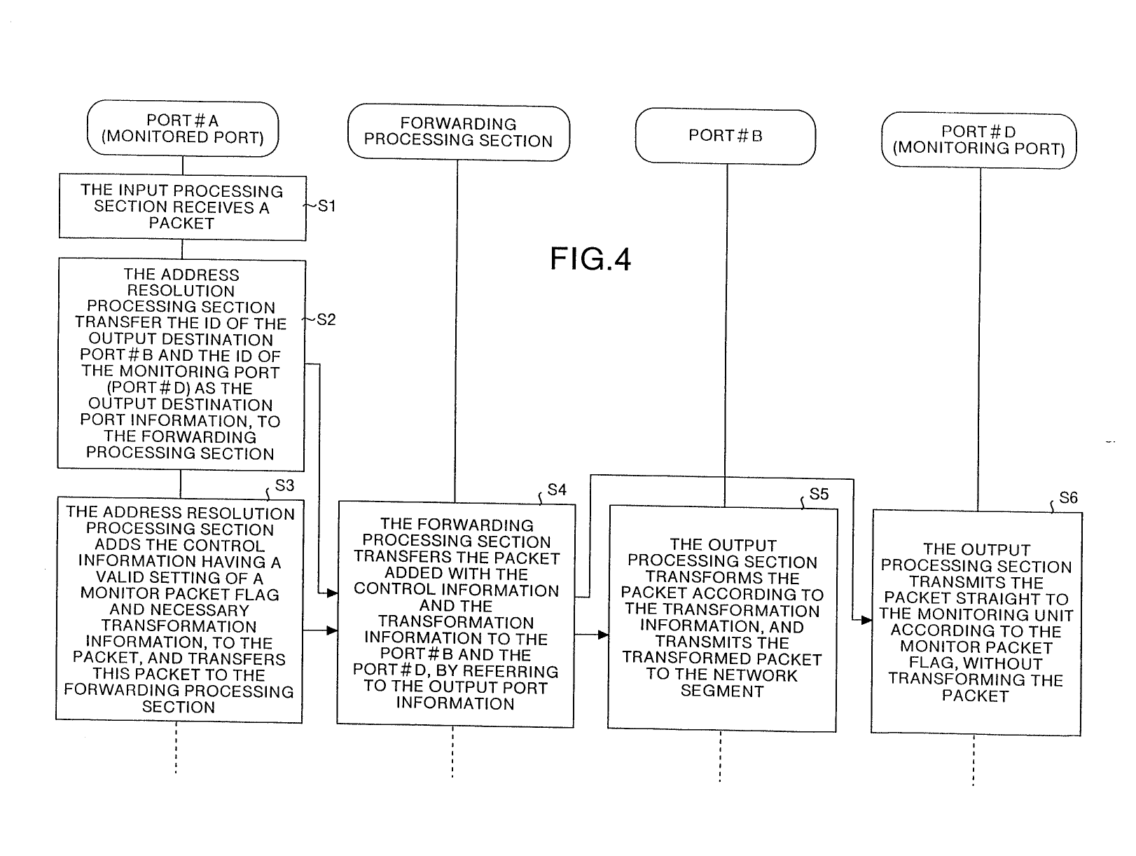

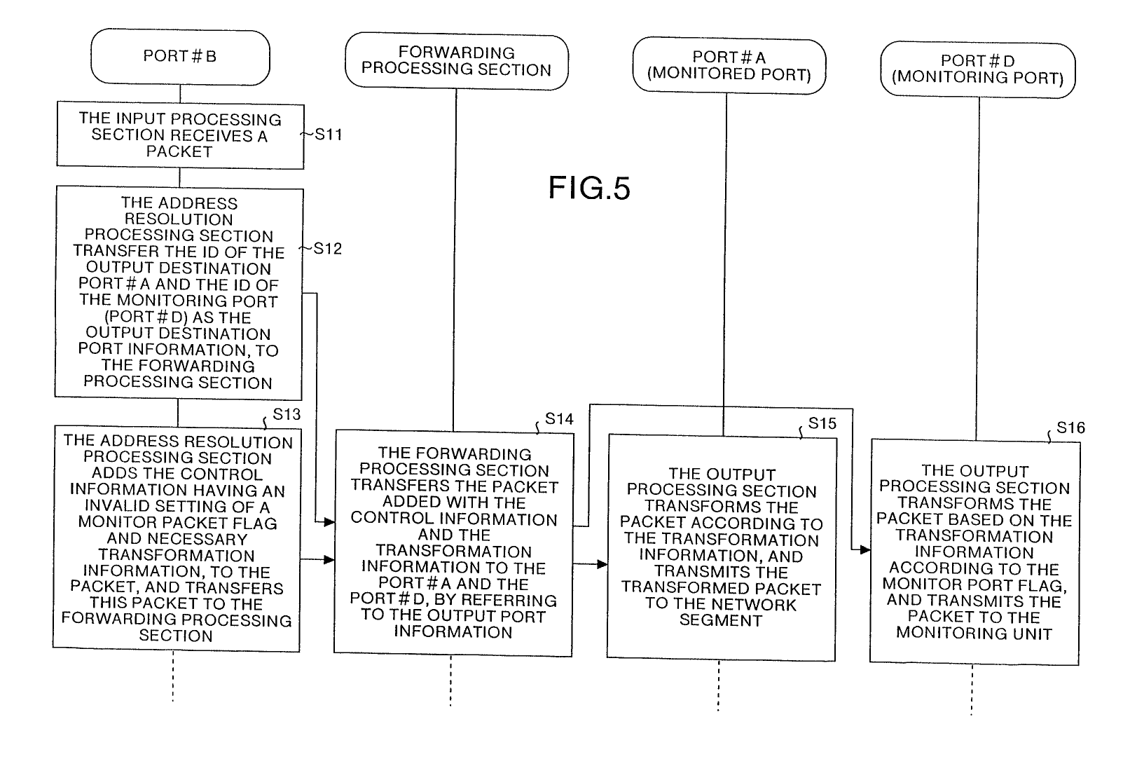

Next, the packet monitoring processing of the network relay installation 1 shown in FIG. 3 will be explained with reference to FIG. 4 and FIG. 5.

(1) A packet monitoring processing of a case where the port # A has received a packet for the port # B (a processing of a packet received by a monitored port) will be explained with reference to FIG. 4. FIG. 4 is a flowchart for explaining a monitoring processing when the port # A (a monitored port) has received a packet destined to the port # B.

In FIG. 4, when the port # A has received a packet in the input processing section 10 from the network segment (LAN # A) (step S1), the address resolution processing section 11 of the port # A searches a predetermined field of the received packet for transmission destination information, and selects an ID of the port # B that is the corresponding output destination port. As the port # A has been set up as a monitored port, the address resolution processing section 11 of the port # A selects an ID of the port # D as a monitoring port. Then, the address resolution processing section 11 of the port # A transfer the output port information of the designated ID of the selected ports (the port # B and the port # D) to the forwarding processing section 2 (step S2).

Further, the address resolution processing section 11 of the port # A adds the control information having a valid setting of a monitor port packet flag and necessary transformation information, to the received packet, and transfers this packet to the forwarding processing section 2 (step S3).

When the output port information and the packet added with the control information and the transformation information have been input to the forwarding processing section 2 from the port # A, the forwarding processing section 2 transfers the packet added with the control information and the transformation information to the transfer destinations (the port # B and the port # D) designated by the output port information, by referring to the output port information (step S4).

When the packet added with the control information and the transformation information has been input to the port # B from the forwarding processing section 2, the output processing section 12 of the port # B transforms the packet according to the transformation information, and transmits the transformed packet to the connected network segment (LAN # B) (step S5). In this case, the packet of the Ethernet format is transformed to a packet of the FDDI format.

When the packet added with the control information and the transformation information has been input to the port # D from the forwarding processing section 2, the output processing section 12 of the port # D judges valid or invalid setting of the monitor port flag included in the control information. In this case, as the monitor port flag has a valid setting, the output processing section 12 transmits the packet to the monitoring unit 3 in the same status as that when the packet has been input to the port # A, without transforming the packet (step S6). As a result, the monitoring unit 3 can monitor the packet in the same status as that when the packet has been input to the port # A.

(2) A packet monitoring processing of a case where the port # B has received a packet for the port # A (a processing of a packet transmitted from a monitored port) will be explained with reference to FIG. 5. FIG. 5 is a flowchart for explaining a monitoring processing when the port # B has received a packet for the port # A.

In FIG. 5, when the port # B has received a packet in the input processing section 10 from the network segment (LAN # B) (step S11), the address resolution processing section 11 of the port # B searches a predetermined field of the received packet for transmission destination information, and selects an ID of the port # A that is the corresponding output destination port. The address resolution processing section 11 of the port # B compares a result of this searching (the ID of the port # A) with the ID of the monitored port. In this case, both IDs coincide with each other. In other words, as the output destination port#A has been setup as a monitored port, the address resolution processing section 11 of the port # B selects an ID of the port # D as a monitoring port. Then, the address resolution processing section 11 of the port # B transfer the output port information of the designated ID of the selected ports (the port # A and the port # D) to the forwarding processing section 2 (step S12).

Further, the address resolution processing section 11 of the port # A adds the control information having an invalid setting of a monitor port packet flag and necessary transformation information, to the received packet, and transfers this packet to the forwarding processing section 2 (step S13).

When the output port information and the packet added with the control information and the transformation information have been input to the forwarding processing section 2 from the port # B, the forwarding processing section 2 transfers the packet added with the control information and the transformation information to the transfer destinations (the port #A and the port # D) designated by the output port information, by referring to the output port information (step S14).

When the port # A has received the packet added with the control information and the transformation information from the forwarding processing section 2, the output processing section 12 of the port # A transforms the packet according to the transformation information, and transmits the transformed packet to the connected network segment (LAN # A) (step S15). In this case, the packet of the FDDI format is transformed to a packet of the Ethernet format.

When the port # D has received the packet added with the control information and the transformation information from the forwarding processing section 2, the output processing section 12 of the port # D judges valid or invalid setting of the monitor port flag included in the control information. In this case, as the monitor port flag has an invalid setting, the output processing section 12 transforms the packet according to the transformation information, and transmits the packet to the monitoring unit 3 in the same status as that when the packet has been output from the port # A (step S16). In this case, the packet of the FDDI format is transformed to a packet of the Ethernet format. As a result, the monitoring unit 3 can monitor the packet in the same status as that when the packet has been output from to the port # A.

As explained above, according to the network relay installation of the present embodiment, at each port, when the self or an output destination port is in the status of being set up as a monitored port at the time when the input processing section 10 has received packets from the network segment, the address resolution processing section 11 transfers output destination port information that specifies the output destination port and a monitoring port, to the forwarding processing section 2. At the same time, the address resolution processing section 11 adds control information that contains information showing whether the self port is in the status of being set up as a monitored port or not and transformation information for transforming packets, to the received packets when the packet transformation is necessary, and transfers the transformed packets to the forwarding processing section 2. The forwarding processing section 2 transfers the packets added with the control information and the transformation information to a designated port, according to the output destination information that has been input from the address resolution processing section 11 of the port. When the self port is in the status of being set up as a monitoring port at the time when the packets added with the control information and the transformation information have been input from the forwarding processing section 2, the output processing section 12 of the port decides whether the received packets are from the monitored port or not by referring to the control information. When the received packets are not from the monitored port, the output processing section 12 transforms the packets based on the transformation information and transmits the transformed packets to the monitoring unit 3. In the mean time, when the received packets are from the monitored port, the output processing section 12 transmits the packets to the monitoring unit 3 without transforming the packets. Therefore, it is possible to output the packets from the monitoring port in the same status as that when the packets have been input to and output from the monitored port. Consequently, it is possible to accurately output the monitored packets from the monitoring port. Further, it is possible to realize the monitoring by omitting complex processing like a separate provision of packets for monitoring. As a result, it is possible to carry out switching and routing efficiently regardless of whether a monitoring is implemented or not.

Further, according to the present embodiment, it is possible to optionally set up the ports # A to # D to a monitored port and a monitoring port. Therefore, it becomes easy to switch over between a packet monitoring port and a packet monitored port.

The present invention is not limited to the above embodiment, and it is also possible to suitably modify the invention within the range of not changing the gist of the invention. The network relay installation of the above embodiment can be widely applied to the routers, bridges, brouters, and switching hubs.

It is also possible to realize the packet monitoring method of the above embodiment by executing a program separately prepared. This program is recorded on a computer-readable recording medium like a hard disk, a floppy disk, a CD-ROM, an MO, and a DVD. A computer executes this program by reading the program from the recording medium. It is possible to distribute this program via a network like the Internet, by using the above recording medium and a transmission medium.

As explained above, in the network relay installation according to the present invention, when the self or an output destination port is in the status of being set up as a monitored port at the time when the address resolution processing section of each of a plurality of ports has received packets from the network segment, the address resolution processing section transfers output destination port information that specifies the output destination port and a monitoring port, to the forwarding processing section. At the same time, the address resolution processing section adds control information that contains information showing whether the self port is in the status of being set up as a monitored port or not and transformation information for transforming packets, to the received packets when the packet transformation is necessary, and transfers the transformed packets to the forwarding processing section. The forwarding processing section transfers the packets added with the control information and the transformation information to a designated port, according to the output destination information that has been input from the address resolution processing section. When the self port is in the status of being set up as a monitoring port at the time when the packets added with the control information and the transformation information have been input from the forwarding processing section, the output processing section of each of the plurality of ports decides whether the received packets are from the monitored port or not by referring to the control information. When the received packets are not from the monitored port, the output processing section transforms the packets based on the transformation information and transmits the transformed packets to the monitoring unit. In the mean time, when the received packets are from the monitored port, the output processing section transmits the packets to the monitoring unit without transforming the packets. Therefore, it is possible to output the packets from the monitoring port in the same status as that when the packets have been input to and output from the monitored port. Consequently, it is possible to accurately output the monitored packets from the monitoring port.

Further, in the network relay installation according to the present invention, when the self port is in the status of not being set up as a monitoring port at the time when the packets added with the control information and the transformation information have been input from the forwarding processing section, the output processing section transforms the packets based on the transformation information, and transmits the transformed packets to the network segment. Therefore, in addition to the above effects of the invention, there is an effect that the output processing section of the output port can transform the packets and transmit the transformed packets to the network segment.

Further, in the network relay installation according to the present invention, the control information includes a flag that shows a valid status when the self port has been set up as a monitored port and that shows an invalid status when the self port has not been set up as a monitored port. Therefore, in addition to the above effects of the invention, there is an effect that the output processing section of the monitoring port can judge whether the input packets are from the monitored port or not, by referring to this flag. Consequently, it becomes easy to judge presence or absence of a packet transformation.

Further, in the network relay installation according to the present invention, it is possible to optionally set up a monitored port and a monitoring port at the plurality of ports. Therefore, in addition to the above effects of the invention, there is an effect that it becomes easy to switch over between a packet monitoring port and a packet monitored port.

Further, in the port monitoring method according to the present invention, at each port, output destination port information that specifies an output destination port and a monitoring port is transferred to a forwarding processing section. At the same time, control information that contains information showing whether the self port is in the status of being set up as a monitored port or not and transformation information for transforming packets, is added to the received packets, when the packet transformation is necessary. Further, the transformed packets are transferred to the forwarding processing section, when the self or the output destination port is in the status of being set up as a monitored port when the packets have been received from the network segment. Further, at the forwarding processing section, the packets added with the control information and the transformation information are transferred to a designated port, according to the output destination information. When the self port is in the status of being set up as a monitoring port at the time when the packets added with the control information and the transformation information have been input from the forwarding processing section, a decision is made on whether received packets are from the monitored port or not by referring to the control information. When the received packets are not from the monitored port, the packets are transformed based on the transformation information, and the transformed packets are transmitted to the monitoring unit. When the received packets are from the monitored port, the packets are transmitted to the monitoring unit without transforming the packets. Therefore, it is possible to output the packets from the monitoring port in the same status as that when the packets have been input to and output from the monitored port. Consequently, it is possible to accurately output the monitored packets from the monitoring port.

Further, in the computer program to be executed according to the present invention, it is possible to realize each step of this method when the computer executes the program. Therefore, through the execution of the computer program, it is possible to output the packets from the monitoring port in the same status as that when the packets have been input to and output from the monitored port. Consequently, it is possible to accurately output the monitored packets from the monitoring port.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A network relay installation that has a plurality of ports for mutually connecting a plurality of network segments, and outputs packets to be input to/output from a port that becomes a monitored port, from a port that becomes a monitoring port to a monitoring unit, wherein
each of said plurality of ports comprises:
an address resolution processing section that transfers output destination port information that specifies an output destination port and a monitoring port, to a forwarding processing section, and at the same time, adds control information that contains information showing whether the self port is in the status of being set up as a monitored port or not and transformation information for transforming packets, to the received packets when the packet transformation is necessary, and transfers the transformed packets to the forwarding processing section, when the self or the output destination port is in the status of being set up as a monitored port when the packets have been received from said network segment;
an output processing section that decides whether received packets are from the monitored port or not by referring to the control information when the self port is in the status of being set up as a monitoring port at the time when the packets added with the control information and the transformation information have been input from said forwarding processing section, and transforms the packets based on the transformation information and transmits the transformed packets to said monitoring unit when the received packets are not from the monitored port, and transmits the packets to said monitoring unit without transforming the packets when the received packets are from the monitored port; and
said forwarding processing section that transfers the packets added with the control information and the transformation information to a designated port, according to the output destination information input from said address resolution processing section.

2. The network relay installation according to claim 1, wherein
when the self port is in the status of not being set up as a monitoring port at the time when the packets added with the control information and the transformation information have been input from said forwarding processing section, said output processing section transforms the packets based on the transformation information, and transmits the transformed packets to the network segment.

3. The network relay installation according to claim 1, wherein
the control information includes a flag that shows a valid status when the self port has been set up as a monitored port and that shows an invalid status when the self port has not been set up as a monitored port.

4. The network relay installation according to claim 1, wherein
it is possible to optionally set up said monitored port and said monitoring port at said plurality of ports.

5. A port monitoring method for monitoring a port that outputs packets to be input to/output from a specific port from a monitoring port, out of a plurality of ports for mutually connecting a plurality of network segments, the port monitoring method comprising the steps of:
transferring, at each port, output destination port information that specifies an output destination port and a monitoring port, to a forwarding processing section, and at the same time, adding control information that contains information showing whether the self port is in the status of being set up as a monitored port or not and transformation information for transforming packets, to the received packets when the packet transformation is necessary, and transferring the transformed packets to the forwarding processing section, when the self or the output destination port is in the status of being setup as a monitored port when the packets have been received from the network segment;
transferring, at said forwarding processing section, the packets added with the control information and the transformation information to a designated port, according to the output destination information; and
deciding whether received packets are from the monitored port or not by referring to the control information when the self port is in the status of being set up as a monitoring port at the time when the packets added with the control information and the transformation information have been input from said forwarding processing section, and transforming the packets based on the transformation information and transmitting the transformed packets to said monitoring unit when the received packets are not from the monitored port, and transmitting the packets to said monitoring unit without transforming the packets when the received packets are from the monitored port.

6. A program for making a computer execute a port monitoring method for monitoring a port that outputs packets to be input to/output from a specific port from a monitoring port, out of a plurality of ports for mutually connecting a plurality of network segments, the program for making a computer execute the steps of:
transferring, at each port, output destination port information that specifies an output destination port and a monitoring port, to a forwarding processing section, and at the same time, adding control information that contains information showing whether the self port is in the status of being set up as a monitored port or not and transformation information for transforming packets, to the received packets when the packet transformation is necessary, and transferring the transformed packets to the forwarding processing section, when the self or the output destination port is in the status of being setup as a monitored port when the packets have been received from said network segment;
transferring, at said forwarding processing section, the packets added with the control information and the transformation information to a designated port, according to the output destination information; and
deciding whether received packets are from the monitored port or not by referring to the control information when the self port is in the status of being set up as a monitoring port at the time when the packets added with the control information and the transformation information have been input from said forwarding processing section, and transforming the packets based on the transformation information and transmitting the transformed packets to the monitoring unit when the received packets are not from the monitored port, and transmitting the packets to said monitoring unit without transforming the packets when the received packets are from the monitored port.
